(19) United States
(12) Patent Application Publication
(10) Pub. No.: US 2014/0290611 A1
(43) Pub. Date: Oct. 2, 2014

(54) NATURAL GAS STORAGE SYSTEM AND METHOD OF IMPROVING EFFICIENCY THEREOF

(71) Applicant: GM Global Technology Operations LLC, Detroit, MI (US)

(72) Inventors: Mahmoud H. Abd Elhamid, Troy, MI (US); Anne M. Dailly, West Bloomfield, MI (US); Mei Cai, Bloomfield Hills, MI (US); Arianna T. Morales, Royal Oak, MI (US)

(73) Assignee: GM Global Technology Operations LLC, Detroit, MI (US)

(21) Appl. No.: 14/222,875

(22) Filed: Mar. 24, 2014

Related U.S. Application Data
(60) Provisional application No. 61/806,025, filed on Mar. 28, 2013.

(51) Int. Cl. F02B 43/02; F17C 1/00

(52) U.S. Cl. CPC F02B 43/02; F17C 1/00
USPC 123/1 A; 206/7; 48/127.3

(57) ABSTRACT

A natural gas storage system includes a container, a natural gas adsorbent positioned in the container, and a heating mechanism operatively positioned to selectively thermally activate the adsorbent. A method for improving efficiency of the natural gas storage system is also disclosed. A predetermined percentage of a capacity of the container for natural gas remaining in the container is identified. In response, a heating mechanism operatively positioned to selectively thermally activate the adsorbent is initiated. The adsorbent is heated and buffer adsorbed gas is released from the adsorbent.

### CROSS REFERENCE TO RELATED APPLICATION

This application claims the benefit of U.S. Provisional Patent Application Ser. No. 61/806,025 filed Mar. 28, 2013, which is incorporated by reference herein in its entirety.

### BACKGROUND

Pressure vessels, such as, e.g., gas storage containers and hydraulic accumulators may be used to contain fluids under pressure. It may be desirable to have a pressure vessel with relatively thin walls and low weight. For example, in a vehicle fuel tank, relatively thin walls allow for more efficient use of available space, and relatively low weight allows for movement of the vehicle with greater energy efficiency.

### SUMMARY

A natural gas storage system includes a container, a natural gas adsorbent positioned in the container, and a heating mechanism operatively positioned to selectively thermally activate the adsorbent. A method for improving efficiency of the natural gas storage system is also disclosed herein. A predetermined percentage of a capacity of the container for natural gas remaining in the container is identified. In response, a heating mechanism operatively positioned to selectively thermally activate the adsorbent is initiated. The adsorbent is heated, and buffer adsorbed gas is released from the adsorbent.

### BRIEF DESCRIPTION OF THE DRAWINGS

Features and advantages of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a schematic view of an example of a natural gas storage system in the form of a tank according to the present disclosure;

FIG. 2 is a schematic view of another example of the natural gas storage system in the form of a tank according to the present disclosure;

FIG. 3 is a schematic view of an example of the natural gas storage system in the form of a cartridge according to the present disclosure;

FIG. 4 is a block diagram depicting an electronics system to control the natural gas storage system of the present disclosure; and

FIG. 5 is a schematic view of a vehicle and the natural gas cartridge for insertion into the vehicle.

### DETAILED DESCRIPTION

Natural gas vehicles are fitted with on-board storage tanks Some natural gas storage tanks are designated as low pressure systems. The low pressure systems are rated for pressures up to about 750 psi (pounds per square inch). In an example of the present disclosure, the low pressure systems may be rated for pressures of about 725 psi and lower. During fueling, the container of the low pressure system storage tank is designed to fill until the tank achieves a pressure within the rated range. Low pressure systems may utilize adsorbed natural gas, where a natural gas adsorbent is loaded into a container of the low pressure system storage tank. The adsorbent increases the storage capacity so that the tank is capable of storing and delivering a sufficient amount of natural gas for desired vehicle operation when filled to the lower pressures. In other words, higher pressure is not required to store a desirable mass of natural gas when an adsorbent is included in the container according to the present disclosure. As an example, at about 725 psi (i.e., 50 bar), a vehicle including a 0.1 m³ (i.e., 100 L) natural gas tank filled with a suitable amount of a carbon adsorbent having a Brunauer-Emmett-Teller (BET) surface area of about 1000 square meters per gram (m²/g), a bulk density of 0.5 grams per cubic centimeter (g/cm³), and a total adsorption of 0.13 grams per gram (g/g) is expected to have 2.85 GGE (gasoline gallon equivalent). Assuming a vehicle may have an expected fuel economy of 30 miles per gallon, 2.85 GGE will allow the vehicle to be operated over a distance range of about 85 miles.

Adsorbents may also be used in designated high pressure systems, which are rated for pressures ranging from about 3,000 psi to about 3,600 psi. Similar to the low pressure systems described above, the container of the high pressure system storage tank is designed to fill until the tank achieves a pressure within the rated range. It is believed that the adsorbent may be used in high pressure systems in order to increase the volumetric based storage capacity (and fuel economy) of high pressure systems.

It is believed that the adsorption effect of the quantity of adsorbent in the examples disclosed herein is high enough to compensate for any loss in storage capacity due to the skeleton of the adsorbent occupying volume in the container. For the same temperature and pressure, the density of the adsorbed phase is greater than the density of the gas in the gas phase. As such, the adsorbent increases the container's storage capacity of compressed natural gas when compared, for example, to the same type of container that does not include the adsorbent.

However, it has also been found that some gas that is stored on the adsorbent may remain unused during vehicle operation. This unused gas is referred to herein as buffer adsorbed gas. The buffer adsorbed gas is a quantity of gas that is retained by an adsorbent at 1 atmosphere pressure. It is estimated that when carbon is used as an adsorbent material, an amount of buffer adsorbed gas having a weight of about 10% to about 20% of the weight of the adsorbed gas remains unused inside the tank at 1 atmosphere pressure (1 atm. is about 14.7 psi) and 25° C. The system and method disclosed herein advantageously recover the buffer adsorbed gas in order to maximize the use of the natural gas in the system and thus enhance system efficiency. As used herein, efficiency means volumetric efficiency of the system for containing and releasing natural gas. For example, the system efficiency may be a ratio of a mass of usable natural gas to a volume of the container 12. A vehicle with the improved system efficiency from the system and method of the present disclosure will experience an increase in distance range.

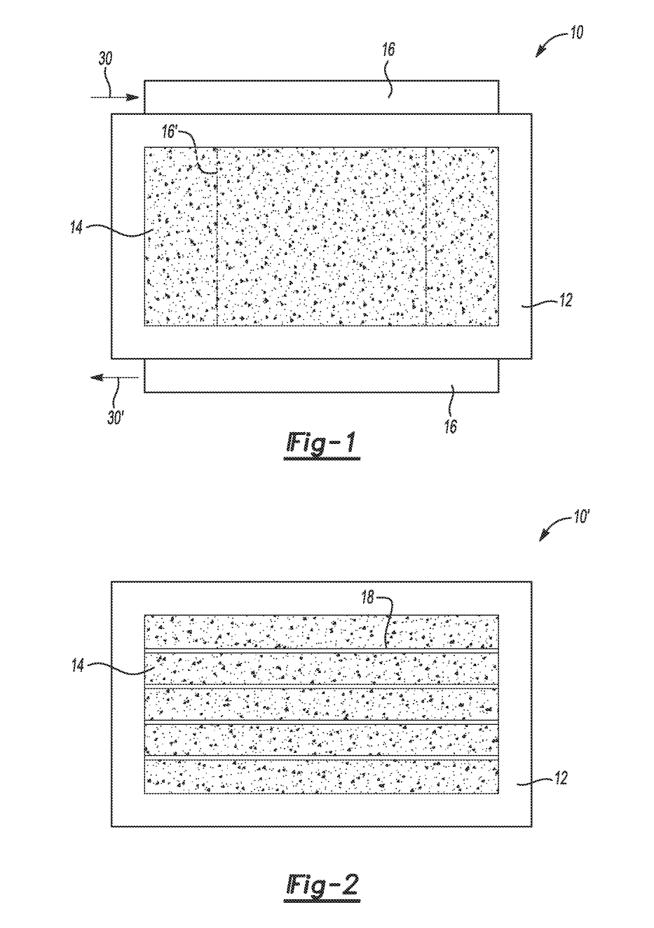

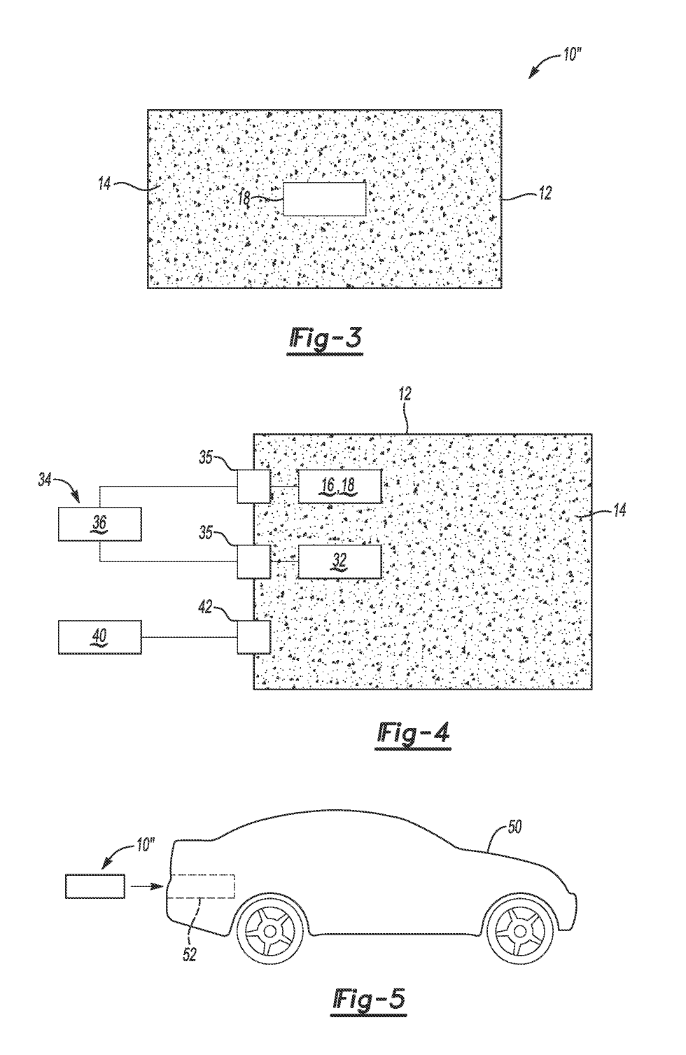

Examples of the natural gas storage system of the present disclosure are shown in FIGS. 1-3. Each of these systems includes a container 12, a natural gas adsorbent 14 positioned in the container 12, and a heating mechanism 16 operatively positioned to selectively thermally activate the adsorbent 14 in the container 12. In the examples shown in FIGS. 1 and 2, the system 10, 10′ is a natural gas tank, and in the example shown in FIG. 3, the system 10″ is a natural gas cartridge. Each of these systems 10, 10′, 10″ will be described hereinbelow. The systems 10, 10′, 10″ may be low pressure systems or high pressure systems. It is to be understood that the low pressure systems disclosed herein may be refillable, or may be configured as a replaceable (stand-alone) system when the pressure used is very low (e.g., about 1 atm.). Alternatively, the natural gas storage systems disclosed herein may be refillable high pressure compressed natural gas (CNG) systems.

Still further, the example high and low pressure natural gas storage systems disclosed herein may be part of a bi-fuel vehicle. In a bi-fuel vehicle, the engine is capable of running on gasoline and on natural gas. In an example of the present disclosure, a bi-fuel vehicle may have a valve to switch between the two fuels. In other examples, the vehicle may be any vehicle that uses natural gas for fuel. For example, the vehicle may have a dedicated natural gas fueled internal combustion (IC) engine, an electric motor combined with a natural gas fueled IC engine (hybrid), or fuel cell powered vehicle that uses natural gas as a fuel.

In each example of the system 10, 10′, 10″, the container 12 may be made of any material that is suitable for a reusable pressure vessel rated for a service pressure up to about 3,600 psi. Examples of suitable container 12 materials include high strength aluminum alloys and high strength low-alloy (HSLA) steels. Examples of high strength aluminum alloys include those in the 7000 series, which have relatively high yield strength. One specific example includes aluminum 7075-T6 which has a tensile yield strength of 73,000 psi. Examples of HSLA steel generally have a carbon content ranging from about 0.05% to about 0.25%, and the remainder of the chemical composition varies in order to obtain the desired mechanical properties. When the container 12 is to be replaceable and used in a very low pressure system (described below in reference to FIG. 3), it is contemplated that other materials, such as plastic or low strength aluminum alloys (e.g., aluminum 6061-T6 or the like), may also be used for the container 12.

While the shape of the container 12 shown in FIGS. 1 and 2 is a rectangular canister, and the shape of the container 12 shown in FIG. 3 is a rectangular cartridge, it is to be understood that the shape and size of the container 12 may vary depending, at least in part, on an available packaging envelope for the tank 10, 10′ or the cartridge 10″ in the vehicle 50 (see FIG. 5). For example, the size and shape may be changed in order to fit into a particular area of a vehicle trunk. As an example, the tank 10, 10′ may be a cylindrical canister.

In the example shown in FIGS. 1-3, the container 12 is a single unit having a single opening or entrance. In each of these examples, the opening may be covered with a plug valve. While not shown, it is to be understood that the container 12 may be configured with other containers so that the multiple containers are in fluid (e.g., gas) communication through a manifold or other suitable mechanism.

As illustrated in each of FIGS. 1-3, the natural gas adsorbent 14 is positioned within the container 12. Suitable adsorbents 14 are at least capable of releasably retaining methane compounds (i.e., reversibly storing or adsorbing and desorbing methane molecules). In some examples, the adsorbent 14 may also be capable of reversibly storing other components found in natural gas, such as other hydrocarbons (e.g., ethane, propane, hexane, etc.), hydrogen gas, carbon monoxide, carbon dioxide, nitrogen gas, and/or hydrogen sulfide. In still other examples, the adsorbent 14 may be inert to some of the natural gas components and capable of releasably retaining other of the natural gas components.

In general, the adsorbent 14 has a high surface area and is porous. The size of the pores is generally greater than the effective molecular diameter of at least the methane compounds. In an example, the pore size distribution is such that there are pores having an effective molecular diameter of the smallest compounds to be adsorbed and pores having an effective molecular diameter of the largest compounds to be adsorbed. In an example, the adsorbent 14 has a BET surface area ranging from about 50 m²/g to about 5,000 m²/g, and includes a plurality of pores having a pore size ranging from about 0.2 nm (nanometers) to about 50 nm.

Examples of suitable adsorbents 14 include carbon (e.g., activated carbons, super-activated carbon, carbon nanotubes, carbon nanofibers, carbon molecular sieves, zeolite template carbons, etc.), zeolites, metal-organic framework (MOF) materials, porous polymer networks (e.g., PAF-1 or PPN-4), and combinations thereof Examples of suitable zeolites include zeolite X, zeolite Y, zeolite LSX, MCM-41 zeolites, silicoaluminophosphates (SAPOs), and combinations thereof Examples of suitable metal-organic frameworks include MOF-5, MOF-8, MOF-177, and/or the like, which are constructed by linking tetrahedral clusters with organic linkers (e.g., carboxylate linkers).

The volume that the adsorbent 14 occupies in the container 12 will depend upon the density of the adsorbent 14. In an example, the density of the adsorbent 14 may range from about 0.1 g/cc to about 0.9 g/cc. A well packed adsorbent 14 may have a density of about 0.5 g/cc. In an example, a container 12 may include 100 pounds (45359 g) of a carbon adsorbent 14. At a total adsorption rate of 0.13 g/g on natural gas into carbon, one would expect to have about 13 pounds (5896 g) of adsorbed natural gas inside the container 12. In this example, 10% of the adsorbed natural gas amounts to about 1.3 pounds (590 g) of buffer adsorbed gas that is left in the container 12 at 1 atm. (14.7 psi) and 25° C. As such, releasing the buffer adsorbed gas as disclosed herein would significantly improve the vehicle 50 distance range.

In examples of the present disclosure, the buffer adsorbed gas may be released at a predetermined rate from the adsorbent. All of buffer adsorbed gas is generally not released immediately and completely upon heating of the adsorbent. The rate of release of the buffer adsorbed gas may be controlled by controlling the rate of heat transfer into the adsorbent.

As disclosed above, the examples of the present disclosure depicted as systems 10, 10′, 10″ in FIGS. 1-3 each include different heating mechanisms that are used to thermally activate the adsorbent 14 in order to release the buffer adsorbed gas. Each of the heating mechanisms will now be described.

Referring now specifically to FIG. 1, the heating mechanism is a heat exchanger 16. The heat exchanger 16 may be operatively positioned on the exterior of the container 12, or may be positioned inside of the container 12 (shown at 16′ in phantom in FIG. 1). In an example, the heat exchanger 16 receives warm/hot liquid engine coolant 30 from an engine coolant circuit (not shown), transfers heat from warm/hot coolant 30 to the adsorbent 14 in the container 12. The warm/hot coolant 30 is delivered to the heat exchanger 16, 16′ via fluid channels that are fluidly connected to the engine coolant circuit of the vehicle 50. Heat from the warm/hot coolant 30 may be transferred to the container 12 by conduction. After heat is transferred from the warm/hot coolant 30, the warm/hot coolant 30′ will have a lower temperature and be returned to the engine coolant circuit of the vehicle 50. The container 12, in turn, heats the adsorbent 14 by conduction and convection. The transfer of heat to the adsorbent 14 may be enhanced by including aspects of the heat exchanger 16′ inside the container 12. For example, fins may be included inside the container 12. In another example, the coolant tubes may be routed inside the container 12. The heat thermally activates the adsorbent 14, which releases the buffer adsorbed gas (e.g., stored methane). The released gas can then be used as fuel.

In a vehicle having a natural gas fuelable IC engine, the heating mechanism may alternatively utilize thermal energy from the engine exhaust gas to release the buffer adsorbed gas. For example, the heat exchanger 16 transfers heat from the hot exhaust gas to the adsorbent 14 in the container 12. As depicted in FIG. 1, the hot engine exhaust gas is depicted entering the heat exchanger 16 at 30 and returning to the exhaust system at 30′. The exhaust gas is delivered to the heat exchanger via fluid channels that are fluidly connected to the exhaust system of the vehicle 50. Heat from the exhaust gas 30 may be transferred to the container 12 by conduction. After heat is transferred from the exhaust gas 30, the exhaust gas 30′ will have a lower temperature and be returned to the exhaust system of the vehicle 50. The container 12, in turn, heats the adsorbent 14 by conduction and convection. In this example, the transfer of heat may be enhanced as previously described. The heat thermally activates the adsorbent 14, which releases the unused buffer adsorbed gas (e.g., stored methane). The released gas can then be used as fuel.

In any of the examples disclosed herein, the target temperature for adsorbent activation will depend, at least in part, on the adsorbent 14 that is used. An example of an adsorbent 14 that may be used is Maxsorb® MSC-30 (Nanoporous Carbon, Kansai Coke and Chemicals Co. Ltd., Japan). A target temperature for activation of Maxsorb® MSC-30 may range from about 30° C. to a maximum of 125° C.

The heating mechanism may also be a microchannel heater(s) 18. These heaters 18 may be used in natural gas vehicles or bi-fuel vehicles. The microchannel heater(s) 18 is/are also shown in the tank 10′ of FIG. 2 and in the cartridge 10″ of FIG. 3. In either example, the microchannel heater(s) 18 may be operatively positioned inside of the container 12. When activated, the microchannel heater(s) 18 generate heat that raises the temperature of the adsorbent 14. The heat thermally activates the adsorbent 14, which releases the unused buffer adsorbed gas (e.g., stored methane). The released gas can then be used as fuel.

Referring now to FIG. 4, any of the examples disclosed herein may include an electronics system 34, which includes a sensor 32 to detect or identify the amount of natural gas present in the container 12 and an electronic controller 36 operatively connected to the heating mechanism 16, 18 and to the sensor 32. In one example, the sensor 32 is a natural gas sensor that can detect when the natural gas in the container 12 reaches a predetermined percentage of the capacity of the container 12 for natural gas, and then in response to this detection, can transmit a signal to the electronic controller 36. In another example, the sensor 32 is a pressure sensor that can detect when the pressure in the container 12 has reached a predetermined level, and then in response to this detection, can determine/identify that the natural gas has also reached a predetermined percentage of the capacity of the container 12 for natural gas and transmit a signal to the electronic controller 36. In response to receiving the signal, the electronic controller initiates the heating mechanism 16, 18. Initiating the heating mechanism 16 may include opening a valve to allow the hot fluid 30 (e.g. hot coolant or exhaust gas) to flow through the heat exchanger. Initiating the heating mechanism 18 may include closing an electrical circuit to allow the heater to begin generating heat. The electronic controller 36 may be programmed to turn the heating mechanism 16, 18 on and off at suitable times and/or in response to suitable conditions. For example, a suitable condition may be when the pressure is below 1 atm.

The tank 10, 10′ or cartridge 10″ may include a fluid connector 42 for selectably releasably connecting the tank 10, 10′ or cartridge 10″ to a fuel system 40 of the vehicle 50. The fluid connector 42 may be a threaded connector, or a quick-connect connector. Further, the tank 10, 10′ or cartridge 10″ may include electrical connectors 35 to electrically connect the sensor 32 and the heating mechanism 18 to the electronics system 34.

The cartridge 10″ shown in FIG. 3 may alternatively be a very low pressurized container 12 (at about 1 atm.) that contains, for example, a specific amount of adsorbent. The cartridge 10″ may be pre-filled with a specific amount of buffer adsorbed gas. For example, the cartridge 10″ as purchased could include about 300 pounds of adsorbent 14 material, and about 30 pounds (5.3 GGE) of buffer adsorbed gas. Other amounts of adsorbent 14 and buffer adsorbed gas could also be used.

In an example of the present disclosure, a plurality of cartridges 10″ may be selectably removably installable on a vehicle 50 in fluid communication through a manifold. The cartridges 10″ may be small enough to be manually lifted and installed on the vehicle 50 without tools. For example, the cartridges 10″ may weigh about 25 pounds when loaded with buffer adsorbed gas. Since the cartridges 10″ in the example are at very low pressure (about 1 atm.), the cartridge 10″ may have relatively thin, lightweight walls. Thus, in this example, a vehicle 50 may be refueled by exchanging a battery of empty cartridges 10″ with a plurality of cartridges 10″ that are loaded with buffer adsorbed gas.

In examples of the present disclosure, the cartridge 10″ may be inserted into the vehicle 50 (as shown, for example, in FIG. 5), and the adsorbent 14 would be heated on demand in the vehicle 50. The heating would release the buffer adsorbed gas for fueling the vehicle 50. This type of cartridge 10″ would eliminate the need for cartridge refilling at the time of vehicle 50 refueling, as the cartridge 10″ would be used on demand and would be replaceable. Once the buffer adsorbed gas is released and used as fuel, the cartridge 10″ would be removed and replaced with another cartridge 10″.

In an example of the present disclosure, the vehicle 50 includes a receiver 52 complementary to the cartridge 10″. The receiver 52 accepts the cartridge 10″ for selectably releasable installation on the vehicle 50. The cartridge 10″ has a predetermined amount of the buffer adsorbed gas preloaded on surfaces of the adsorbent 14. The buffer adsorbed gas is to be selectably releasable to be consumed as fuel by an engine of the vehicle 50. The cartridge 10″ is exchangeable with another cartridge to refuel the vehicle 50 after the predetermined amount of buffer adsorbed gas has been released from the cartridge 10″.

While the low and very low pressure natural gas systems disclosed herein have been described as being for a vehicle, it is to be understood that this system may be used in other, non-automotive applications that utilize natural gas.

It is to be understood that the ranges provided herein include the stated range and any value or sub-range within the stated range. For example, a range from about 0.1 g/cc to about 0.9 g/cc should be interpreted to include not only the explicitly recited limits of about 0.1 g/cc to about 0.9 g/cc, but also to include individual values, such as 0.25 g/cc, 0.49 g/cc, 0.8 g/cc, etc., and sub-ranges, such as from about 0.3 g/cc to about 0.7 g/cc; from about 0.4 g/cc to about 0.6 g/cc, etc. Furthermore, when “about” is utilized to describe a value, this is meant to encompass minor variations (up to +/−10%) from the stated value.

In describing and claiming the examples disclosed herein, the singular forms “a”, “an”, and “the” include plural referents unless the context clearly dictates otherwise.

It is to be understood that the terms “connect/connected/connection” and/or the like are broadly defined herein to encompass a variety of divergent connected arrangements and assembly techniques. These arrangements and techniques include, but are not limited to (1) the direct communication between one component and another component with no intervening components therebetween; and (2) the communication of one component and another component with one or more components therebetween, provided that the one component being “connected to” the other component is somehow in operative communication with the other component (notwithstanding the presence of one or more additional components therebetween).

Furthermore, reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

While several examples have been described in detail, it will be apparent to those skilled in the art that the disclosed examples may be modified. Therefore, the foregoing description is to be considered non-limiting.

What is claimed is:

1. A natural gas storage system, comprising:
a container;
a natural gas adsorbent positioned in the container; and
a heating mechanism operatively positioned to selectively thermally activate the adsorbent.

2. The natural gas storage system as defined in claim 1, further comprising:
a sensor to detect a percentage of a capacity of the container for natural gas present in the container; and
an electronic controller operatively connected to the heating mechanism and to the sensor, the electronic controller to initiate the heating mechanism upon receiving a signal from the sensor indicating that the predetermined percentage of the capacity of the container for natural gas is present in the container.

3. The natural gas storage system as defined in claim 1 wherein the heating mechanism is selected from a heat exchanger and a microchannel heater.

4. The natural gas storage system as defined in claim 3 wherein the heat exchanger is to transfer heat from a liquid engine coolant to the adsorbent.

5. The natural gas storage system as defined in claim 3 wherein the heat exchanger is to transfer heat from engine exhaust gas to the adsorbent.

6. The natural gas storage system as defined in claim 1 wherein the natural gas adsorbent is selected from the group consisting of a carbon, a porous polymer network, a metal-organic framework, a zeolite, and combinations thereof.

7. The natural gas storage system as defined in claim 1 wherein the container is a tank.

8. The natural gas storage system as defined in claim 1 wherein the container is a cartridge.

9. The natural gas storage system as defined in claim 8 wherein the cartridge is installable on a vehicle with a predetermined amount of buffer adsorbed gas preloaded on surfaces of the adsorbent, the buffer adsorbed gas to be selectably releasable to be consumed as fuel by an engine of the vehicle.

10. The natural gas storage system as defined in claim 1 wherein the container has a service pressure rating of about 3,600 psi (pounds per square inch) to be filled with natural gas at a tank pressure up to about 3600 psi.

11. The natural gas storage system as defined in claim 1 wherein the container has a service pressure rating of about 725 psi (pounds per square inch) to be filled with natural gas at a tank pressure up to about 725 psi.

12. The natural gas storage system as defined in claim 1 wherein the container has a service pressure rating of about 14.7 psi (pounds per square inch) to be filled with natural gas at a tank pressure up to about 14.7 psi.

13. A method for improving efficiency of a natural gas storage system, the method comprising:
identifying that a predetermined percentage of a capacity of a container for natural gas remains in the container having a natural gas adsorbent therein; and
in response to the identifying, initiating a heating mechanism operatively positioned to selectively thermally activate the adsorbent, thereby heating the adsorbent and releasing buffer adsorbed gas from the adsorbent at a predetermined rate.

14. A vehicle, comprising:
an internal combustion engine capable of consuming natural gas as a fuel; and
a natural gas storage system including:
a container;
a natural gas adsorbent positioned in the container;
a heating mechanism operatively positioned to selectively thermally activate the adsorbent;
a sensor to detect a predetermined percentage of a capacity of the container for natural gas present in the container; and
an electronic controller operatively connected to the heating mechanism and to the sensor, the electronic controller to initiate the heating mechanism upon receiving a signal from the sensor indicating that the predetermined percentage of the capacity of the container for natural gas is present in the container.

15. The vehicle as defined in claim 14 wherein the container is a cartridge.

16. The vehicle as defined in claim 15 wherein the vehicle further includes a receiver complementary to the cartridge, the receiver to accept the cartridge for selectably releasable installation on the vehicle, the cartridge having a predetermined amount of buffer adsorbed gas preloaded on surfaces of the adsorbent, the buffer adsorbed gas to be selectably releasable to be consumed as fuel by an engine of the vehicle, the cartridge being exchangeable with an other cartridge to refuel the vehicle after the predetermined amount of buffer adsorbed gas has been released from the cartridge.

17. The vehicle as defined in claim 16 wherein the cartridge includes a fluid connector for selectably releasably connecting the cartridge to a fuel system of the vehicle.

18. The vehicle as defined in claim 17 wherein the fluid connector is a quick-connect connector.

19. The vehicle as defined in claim 16 wherein the cartridge includes an electrical connector to electrically connect the sensor and the heating mechanism to the electronic controller.
